(19) United States
(12) Patent Application Publication
(10) Pub. No.: US 2009/0012893 A1
(43) Pub. Date: Jan. 8, 2009

(54) Trading System

(75) Inventor: James Davies, Greater London (GB)

Correspondence Address: DEAN P. ALDERUCCI, CANTOR FITZGERALD, L.P., 110 EAST 59TH STREET (6TH FLOOR), NEW YORK, NY, 10022, US

(73) Assignee: eSpeed, Inc., New York, NY (US)

(21) Appl. No.: 12/053,487

(22) Filed: Mar. 21, 2008

Related U.S. Application Data
(60) Provisional application No. 60/896,259, filed on Mar. 21, 2007.

(51) Int. Cl. G06Q 40/00

(52) U.S. Cl. 705/37

(57) ABSTRACT

A method for enabling collaborative processing of data by one or more computers or digital data processing systems. The computer(s) compute a value representative of a first yield for a first instrument, the first instrument being a derivative of an underlying financial instrument, the first instrument being a non-fixed-income instrument. The computer(s) compute a second yield of a second financial instrument. The computer(s) control automated trading of the first instrument based at least in part on comparison of the first yield value with a computed second yield of a second financial instrument, and/or based on comparison of a differential of the first instrument value over change in market interest rates against a differential of the second instrument value over change in market interest rates, the control balancing sizes of positions in the first instrument and second instrument to achieve a desired financial risk profile.

This application claims priority from provisional application Ser. No. 60/896,259 filed Mar. 21, 2007.

### BACKGROUND

The invention relates to means or steps for enabling collaborative processing of data by computers or digital data processing systems.

### SUMMARY

In general, in a first aspect, the invention features a method for enabling collaborative processing of data by one or more computers or digital data processing systems. The computer(s) compute a value representative of a first yield for a first instrument, the first instrument being a derivative of an underlying financial instrument, the first instrument being a non-fixed-income instrument. The computer(s) compute a second yield of a second financial instrument. The computer(s) control automated trading of the first instrument based at least in part on comparison of the first yield value with a computed second yield of a second financial instrument, and/or based on comparison of a differential of the first instrument value over change in market interest rates against a differential of the second instrument value over change in market interest rates, the control balancing sizes of positions in the first instrument and second instrument to achieve a desired financial risk profile.

Embodiments of the invention may include one or more of the following features. The first instrument may be a bond futures contract. The second instrument may be a bond futures contract. The second instrument may be a bond. At least one of the differentials may be a DV01 value. The controlling of automated trading may be designed to synthesize a financial instrument at the spread between the first and second instruments. A display screen may display a market for the synthesized financial instrument to a human user. A non-linear calculation of the first yield around a value calculated from a price of the first instrument may be used. The first yield may be calculated based on a yield of the underlying instrument, the underlying instrument being a bond. The underlying instrument may be a cheapest-to-deliver bond from among a basket of bonds within the scope of the futures contract governing trading of the first instrument.

The above advantages and features are of representative embodiments only, and are presented only to assist in understanding the invention. It should be understood that they are not to be considered limitations on the invention as defined by the claims. Additional features and advantages of embodiments of the invention will become apparent in the following description, from the drawings, and from the claims.

### DESCRIPTION OF THE DRAWINGS

FIGS. 1-2 are displays of market data in a trading system.

FIG. 3 is a display of an order entry screen in a trading system.

### DESCRIPTION

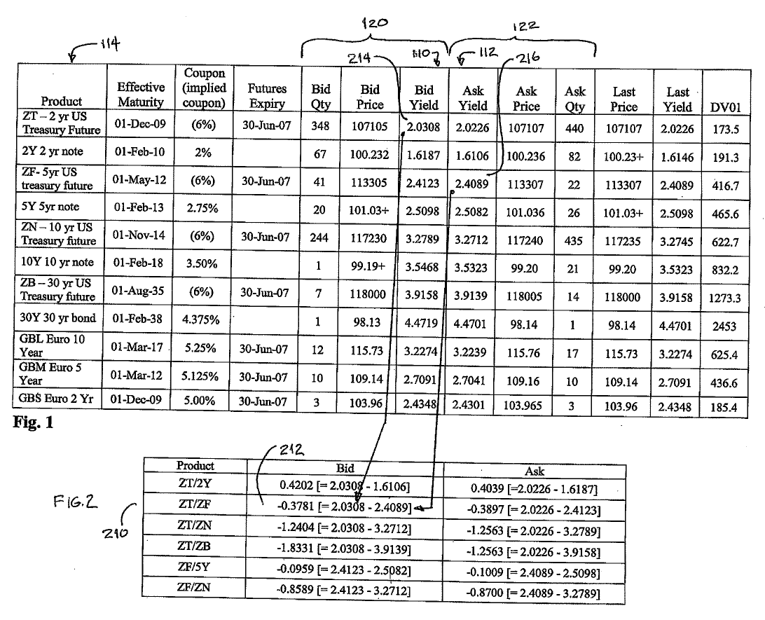

Referring to FIG. 1, a trading system for trading financial products may have a mode that displays illustrative yield values 110, 112 for the financial products 114 traded. As one example of such a display, in a system for trading bond futures contracts, the bids to buy 120 and offers to sell 122 the contracts may show quantities, bid prices, the bid price expressed as a illustrative yield 110, an ask price expressed as a yield 112, an ask price, and a quantity of the ask orders. The system may permit users to enter spread trades, that is, synthetic trades that result in an underlying buy and sell of roughly comparable quantities of two instruments, so that the economics of the position reflects the behavior of the spread between the two instruments. The system may use certain mathematical calculations performed on a computer to automatically calibrate the sizes of the two trades so that the directional up and down market risk of the spread can be reduced and thus the market-neutrality of the spread can be increased, thereby singling out the single financial risk factor sought to be traded (the relative yield difference between the two instruments).

Trading systems for other products may also display yields. Examples of financial products whose yields may be useful in making trading decisions are generally fixed-income instruments and some derivatives thereof, including bonds, loans, bond forwards or futures, bond options, options on bond futures, bond shorts, stripped bonds, strips, inverse floating agreements, interest rate and currency derivatives (forwards, futures, options, swaps, swaptions, etc.), mortgage-backed securities and their derivatives, collateralized debt obligations and their derivatives, credit default swaps and other credit enhancements, and others. Other examples of financial instruments whose yields may be displayed include convertible or preferred stock, income-producing stocks, income-producing portfolios of equities including mutual funds, exchange traded funds.

Because a bond futures contract does not pay fixed income cash flows, the “yield” of a futures contract is a somewhat artificial construct that is most useful to compare relative magnitudes to each other, and to compute hedge ratios between offsetting positions to remain relatively risk neutral to the overall market directional movement. Generally, a yield calculation for a futures contract may involve calculating a portion of the yield for the underlying bonds that fall within the life of the futures contract. In other cases, the yield calculation may be based on the deviation of a single proxy bond's current price from par (often called the “Cheapest to Deliver” bond from a basket of bonds underlying the futures contract as per that contract's specification) as implied by the futures contract's, fluctuation of the futures' price toward the final settlement price of the contact. Accordingly, different formulae may be used to determine illustrative yields of different futures contracts or in different contexts for the same futures contract, to tailor the calculation to the precise purpose required. The trading system may permit users to input and use their own choices of formula. The provider of the trading system may also supply a default formula for computing yield. The precise formula chosen may depend on the trader's preferences, the types of positions that are being taken to offset each other, various risks that should be factored in, and whether the futures contracts in use actually imply a “Cheapest to Deliver” bond that can be used as a proxy for the contract. In some cases, a yield calculation may also consider transaction costs, and taxes.

The value of a bond is computed by the following formula, which discounts each of the coupons and the final bullet payment to present value (for simplicity, assuming biannual coupons, that the bond is newly-issued or that the last biannual coupon has just been paid, is due in six months, and that the face value of the bond and the last coupon are to be paid n years in the future

$$\frac{c}{{( 1 + r )}^{0.5}} + \frac{c}{{( 1 + r )}^{1.0}} + \frac{c}{{( 1 + r )}^{1.5}} + \frac{c}{{( 1 + r )}^{2.0}} + … + \frac{c}{{( 1 + r )}^{n}} c + \frac{B}{{( 1 + r )}^{n}} = P$$

where:
P=purchase price, current market price of the bond
B=bond face value, or par value
r=the yield
   One formula for computing a illustrative yield of a futures contract involves separating out the terms of this equation relating to those coupons that mature during the term of the futures contract from those that mature after the expiry of the futures contract. Once those terms are separated, they may be used to compute the present value of the cash flows that remain outstanding on the expiry date of the futures contract to obtain the expected price of the bond on that date, and comparing that value to the price of the bond today, and computing the yield based on that difference.

Another possible formulas for computing the yield of a bond future is as follows:

$$yield = ( \frac{contract price of the future}{current market price of the underlying instrument} \times \frac{365}{days to delivery} ) - cost of carry$$

Another calculation, for cases where the contract specification for the futures contract implies a “cheapest to deliver” (CTD) bond among a basket of bonds that may be delivered into the contract, may be the yield computed by computing yields on the underlying cheapest-to-deliver bond based on
the actual maturity date of the cheapest-to-deliver (as opposed to the nominal maturity date of the notional future)
the conversion factor for the cheapest-to-deliver bond (as determined by the conversion formula defined by the futures contract)
the current contract price, in percentage form

Another possible calculation may be based on computing the change in the bond's value due to imputed coupon interest between today and the futures delivery date, and converting that change in value over that period of time to a yield.

In some cases, for example where a bond, and or the futures contract, is trading well above par (100% nominal value), and depending on the factors considered in choosing the yield calculation to be used, the “yield” on the futures position may be negative.

In some cases, depending on the financial role contemplated for the futures position—for example, whether it is being entered for its own sake, or to offset another position—the cost of carry may be subtracted from the yield computed above.

For a buyer, the cost of carrying the contract may reflect the cost of the margin held by the clearer of the contracts. The delivery date used in the “days to delivery” term may generally be assumed to be the least favorable, that is, at the beginning of the contract month if the cost of carry is less than ve for that bond The cost of carry may be computed by a number of methods, including the method discussed in Don Chance, A Generalization of the Cost of Carry Forward/Futures Pricing Model, Financial Engineering News, parts 1 and 2, March-April 2006 and May-June 2006, which is incorporated by reference.

Values corresponding to the forward DV01 (the slope of the price-to-yield curve) of the underlying implied cheapest-to-deliver bond on futures expiry date may be calculated and displayed. DV01 is defined as the dollar value increase for each one basis point (1 bP) decrease (in interest rates), defined as

$$DV 01 = - 0.0001 \times \frac{d P}{d r}$$

where P is the price of the bond or future, and r is the market interest rate. DV01 is a sensitivity measure of how much a bond's price or a futures' price will increase in response to a one basis point decline in bond's yield to maturity. For example, the DV01 parameter of a CBOT futures contract may be assumed to be the DV01 of the implied “cheapest to deliver” bond in the basket associated with the futures contract, as implied by the futures price and calculated as if on the futures expiry date.

Referring to FIG. 2, ratios or differences of these yield values may be computed and displayed to guide a trader in trading, or arbitraging one position against another, or hedging one position against another. A real trading screen would show the three columns of numbers, without the subtraction shown in square brackets—the computations are shown in this example for clarity.

The computations of yield on various instruments may permit the creation of synthetic “yield spread” instruments that may be synthesized by buying one instrument long and selling the other short. For example, a “ZT/ZF” instrument may be synthesized by buying a long future on ZT (the 2 year treasury future) and selling a short position on ZF (the 5 year future). The yield spread 212 on this instrument is the difference between the bid yield 214 on ZT and the ask yield 216 on ZF.

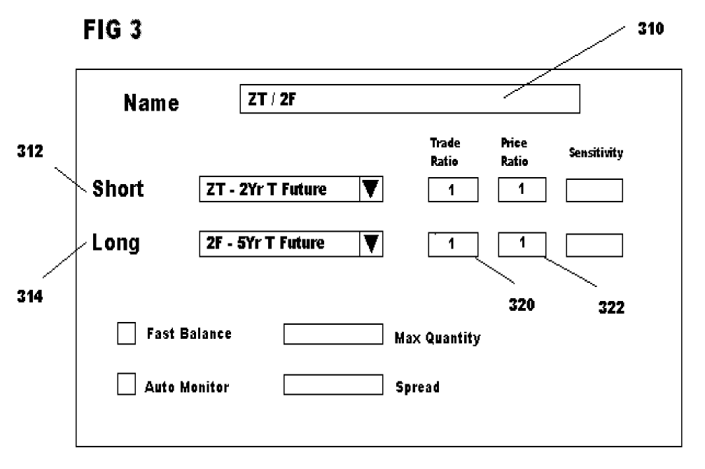

Referring to FIG. 3, a “spreader” computer application may be used to create spread trades between two instruments. A user may specify a desired spread in yield between two instruments, and the spreader will view the market data (bids and offers) for the two instruments, and will enter two trades when the bid/offer prices reach the desired spread from each other. Spreaders are known tools for trading securities. One spreader is available from Ecco Ware, described at http://www.eccoware.com/eccospreader.php. The EccoSpreader Guide for the Ecco Ware spreader is incorporated by reference. In brief overview, a spreader works two limit orders, a limit bid on a first instrument that is maintained at a fixed spread from the current market bid of a second instrument, and a limit ask on said second instrument that is maintained at a fixed spread from the current market bid of said first instrument. If either of these two limit orders is ever traded, then the spreader trades the corresponding market order at the opposite side of the spread trade, thereby entering two orders that are at a requested spread from each other as promptly as the computer application and futures exchange latencies will allow.

The spreader may recalculate sizes of the two orders being propagated to their respective exchanges as above to track changes in price of the two instruments in the spread, to achieve a desired hedge ratio upon trading. In some cases, the ratio between the two sizes may be computed as the ratio of the DV01 values for the two instruments (either implied DV01 for a futures instrument or actual computed DV01 for a cash bond instrument). By structuring the two trades to have a neutral hedge ratio (a hedge ratio that means the overall spread trade economics are as unaffected as possible by the up or down price direction of the overall market), the overall trade may be structured to remove the effects of overall market movement, and focus on a specific relative movement of the first and second instruments chosen, for example, the fluctuation of the interest rate differential between 2-year vs. 5-year securities. In some cases, it may be desirable to allow the balance to shift in one direction or the other as prices move, to reflect a hedging strategy of the trader. The spreader may permit the user to control this ratio.

In cases where the spread is calculated based on difference in yield between two futures, the artificiality of the yield calculation becomes essentially less important, because the two artificial yields are subtracted from each other. In cases where the spreader is used to enter a spread trade between a future and some other security, the yield formula may need to be tuned to the definition of yield of the other security to arrive at two numbers that can be meaningfully compared to each other. Alternatively, the yield difference may be viewed as simply a number with an equilibrium value, and the arbitrage opportunity for the synthetic difference instrument arises when the value strays from that equilibrium value or diversion from the mean value of the synthetic yield difference if that value is seen by the trader as a mean reverting spread.

Over short movements of price, the yield difference between one price level and another may be calculated as a linear interpolation around the first yield calculated and the DV01 calculated. As the price moves further, the yield calculation may need to be more precise to reflect the non-linearity of the yield-to-price relationship.

In the example of FIG. 3, a spread between ZT (the trading symbol for the futures contract on the two-year U.S. Treasury bond) and ZF (the trading symbol for the futures contract on five-year U.S. Treasury bonds) can be synthesized by selecting ZT as the security to short 312 and ZF as the security to buy long 314. The spreader may, by default, choose the ratios of the calculated DV01 values of the two underlying securities as the ratios for the two trades to be entered. A user may increase or decrease this ratio using appropriate controls 320, 322.

The user may indicate other controls on the spread order, including whether to enter the orders as market orders or limit orders, “extra ticks” to slightly enlarge or narrow the desired spread level the application is required to trade, the sensitivity of the working order against changes in the opposite side of the market, clip sizes (the size of each order to work in the first and second instruments), timing for entering a balancing market order when an execution is received in the first or second instruments (e.g., if a working bid is executed in the first instrument, is a new balancing order in the second market instrument entered immediately or only after the order in the second market instrument already working is confirmed cancelled by the exchange), and the like.

The system may be implemented in a computer trading system or in a computer application connecting to multiple trading systems. In one architecture for a computer trading system, one or more central matching computers maintain books of bids and offers, and match them to execute trades, and/or may permit uses to hit and lift the bids and offers to execute trades. Trader users of the system may have workstations that either display trading information on a screen for display to humans, and to receive order information from humans at input devices. Trader users may have algorithmic automated systems that enter bids, offers, hits and lifts automatically. These computers may be connected by proprietary, leased private, or public networks.

For the convenience of the reader, the above description has focused on a representative sample of all possible embodiments, a sample that teaches the principles of the invention and conveys the best mode contemplated for carrying it out. Throughout this application and its associated file history, when the term “invention” is used, it refers to the entire collection of ideas and principles described; in contrast, the formal definition of the exclusive protected property right is set forth in the claims, which exclusively control. The description has not attempted to exhaustively enumerate all possible variations. Other undescribed variations or modifications may be possible. Where multiple alternative embodiments are described, in many cases it will be possible to combine elements of different embodiments, or to combine elements of the embodiments described here with other modifications or variations that are not expressly described. In many cases, one feature or group of features may be used separately from the entire apparatus or methods described. Many of those undescribed variations, modifications and variations are within the literal scope of the following claims, and others are equivalent.

The invention claimed is:

1. A method, comprising the steps performed on one or more computers, of:
computing a value representative of a first yield for a first instrument, the first instrument being a derivative of an underlying financial instrument, the first instrument being a non-fixed-income instrument;
computing a second yield of a second financial instrument; and
controlling automated trading of the first instrument based at least in part on comparison of the first yield value with a computed second yield of a second financial instrument, and/or based on comparison of a differential of the first instrument value over change in market interest rates against a differential of the second instrument value over change in market interest rates, the control balancing sizes of positions in the first instrument and second instrument to achieve a desired financial risk profile.

2. The method of claim 1, wherein the first instrument is a bond futures contract.

3. The method of claim 2, wherein the second instrument is a bond futures contract.

4. The method of claim 2, wherein the second instrument is a bond.

5. The method of claim 2, wherein the controlling of automated trading is based at least in part on a comparison of the first yield value with a computed second yield of a second financial instrument

6. The method of claim 2, wherein the controlling of automated trading is based at least in part on comparison of a differential of the first instrument value over change in market interest rates against a differential of the second instrument value over change in market interest rates.

7. The method of claim 6, wherein at least one of the differentials is a DV01 value.

8. The method of claim 2, wherein the controlling of automated trading is designed to synthesize a financial instrument at the spread between the first and second instruments.

9. The method of claim 8, wherein a display screen displays a market for the synthesized financial instrument to a human user.

10. The method of claim 2, wherein the controlling uses a non-linear calculation of the first yield around a value calculated from a price of the first instrument.

11. The method of claim 2, wherein the first yield is calculated based on a yield of the underlying instrument, the underlying instrument being a bond.

12. The method of claim 11, wherein the underlying instrument is a cheapest-to-deliver bond from among a basket of bonds within the scope of the futures contract governing trading of the first instrument.

13. One or more tangible computer memories, having embedded thereon one or more programs to cooperate to cause one or more computers to:
compute a value representative of a first yield for a first instrument, the first instrument being a derivative of an underlying financial instrument, the first instrument being a non-fixed-income instrument;
compute a second yield of a second financial instrument; and
control automated trading of the first instrument based at least in part on comparison of the first yield value with a computed second yield of a second financial instrument, and/or based on comparison of a differential of the first instrument value over change in market interest rates against a differential of the second instrument value over change in market interest rates, the control balancing sizes of positions in the first instrument and second instrument to achieve a desired financial risk profile.

14. The method of claim 13, wherein the first instrument is a bond futures contract.

15. The method of claim 13, wherein the second instrument is a bond futures contract.

16. The method of claim 13, wherein the second instrument is a bond.

17. The method of claim 13, wherein the controlling of automated trading is based at least in part on a comparison of the first yield value with a computed second yield of a second financial instrument

18. The method of claim 13, wherein the controlling of automated trading is based at least in part on comparison of a differential of the first instrument value over change in market interest rates against a differential of the second instrument value over change in market interest rates.

19. The method of claim 13, wherein the controlling of automated trading is designed to synthesize a financial instrument at the spread between the first and second instruments.

20. The method of claim 13, wherein the first yield is calculated based on a yield of the underlying instrument, the underlying instrument being a bond.
